(19) United States
(12) Patent Application Publication
(10) Pub. No.: US 2011/0154604 A1
(43) Pub. Date: Jun. 30, 2011

(54) PVA SPONGE WITH VEGETAL STARCH AND BAMBOO CHARCOAL AND METHOD TO PREPARE ONE

(76) Inventor: Hung-Hua Chang, Shinjhu (TW)

(21) Appl. No.: 12/647,550

(22) Filed: Dec. 28, 2009

(51) Int. Cl. A47L 13/16; C08J 9/06

(52) U.S. Cl. 15/244.4; 264/54

(57) ABSTRACT

A PVA sponge with vegetal starch and bamboo charcoal includes at least one Polyester fiber substrate having through pores inside thereof, and a PVA foaming material having vegetal starch and bamboo charcoal therein. The substrate is covered by the PVA foaming material and will have acetalization by formaldehyde. The substrate is placed into a container with a predetermined shape and the PVA foaming material mixed with formaldehyde and hydrochloric is poured into the container. The colloid PVA and formaldehyde will have acetalization so that the PVA foaming material will cover among the structure of the substrate. A heating-up forming process is carried out when the PVA foaming material is full of the container. The added hydrochloric is an accelerator to accelerate the reaction.

### FIELD OF THE PRESENT INVENTION

The present invention relates to foaming sponge, and particular to a PVA foaming sponge having vegetal starch and bamboo charcoal and the method to prepare one.

### DESCRIPTION OF THE PRIOR ART

Sponges are usually wetted to clean so that the water absorption is the primary concern for making sponges. The hydrophilic PVA foaming material is thus becoming a most common material for making sponges. The hydrophilic PVA foaming sponge is capable of adsorbing dirt and water. However, the PVA foaming sponge is soft and has smooth surfaces or cavities on surfaces so that it is incapable of removing the dirt stuck on the floor.

The sponges for cleaning dinning dishes or bowls are usually having a special process or glue on a surface so as to make the surface roughly. Or, an artificial fiber is attached to the surface of the sponge for efficiently cleaning the greasiness remained on the dishes. Such sponges will need extra cost for additional process, and the whole sponge is useless if the cleaning surface is abraded.

Because of the disadvantages of the prior sponges, the inventor of the present invention provides an overall improvement so as to raise the cleaning performance.

### SUMMARY OF THE PRESENT INVENTION

Accordingly, the present invention is a PVA foaming sponge with vegetal starch and bamboo charcoal and method to prepare one. The sponge structure is made of fabric substrate covered by the PVA foaming material having vegetal starch and bamboo charcoal. By the PVA foaming material, the sponge is capable of absorbing water fast. By the rough surface of the substrate revealed from the sponge, the cleaning ability of the sponge will be extremely raised. The substrate provides better tenacity and cleaning function to the sponge, and the life time is also lengthened because the substantial structure of the sponge. With the high ventilation and resilience thereof, water is also easier squeezed out. The sponge of the present invention is deodorant, antibiotic, and anti-mildew by the charcoal added therein. Moreover, the Polyester fiber provides good water permeability and tenacity.

The bamboo charcoal is capable of purifying water and air, releasing mineral and ion, antiseptic, radiating far infrared, helping blood circulation, blocking electromagnetic wave, modulating temperature and humidity, and driving out the white ants. The bamboo charcoal also has outstanding ability of adsorption, deodorization, removing moisture and decomposing pernicious gases such as the solvent remained of house decoration. Therefore, the bamboo charcoal is added to the present invention so as to do good to human health. Moreover, the sponge of the present invention is capable of eliminating germs in the water while it is placed in the water.

To achieve above objects, the present invention provides a PVA foaming sponge with vegetal starch and bamboo charcoal including at least one Polyester fiber substrate having through pores inside thereof, and a PVA foaming material having vegetal starch and bamboo charcoal therein. The substrate is covered by the PVA foaming material and will have acetalization by formaldehyde. The substrate is placed into a container with a predetermined shape, and the PVA foaming material mixed with formaldehyde and hydrochloric is poured into the container. The colloid PVA and formaldehyde will have acetalization so that the PVA foaming material will cover among the structure of the substrate. A heating-up forming process is carried out when the PVA foaming material is full of the container. The added hydrochloric is an accelerator to accelerate the reaction.

The present invention will be further described with the following description and drawings.

### BRIEF DESCRIPTION OF THE DRAWINGS

FIG. 1 is a flow chart of the steps of the present invention.

FIG. 2 is a schematic view showing a substrate of the present invention.

FIG. 3 is a schematic view showing a structure of the substrate added with the PVA foaming material.

FIG. 4 is a schematic view showing the PVA foaming material added to the substrate.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention provides a method of forming an improved structure of a hydrophilia polyvinyl acetal (PVA) sponge having outstanding cleaning effect and substantial structure.

The structure and technique will be described with following drawings.

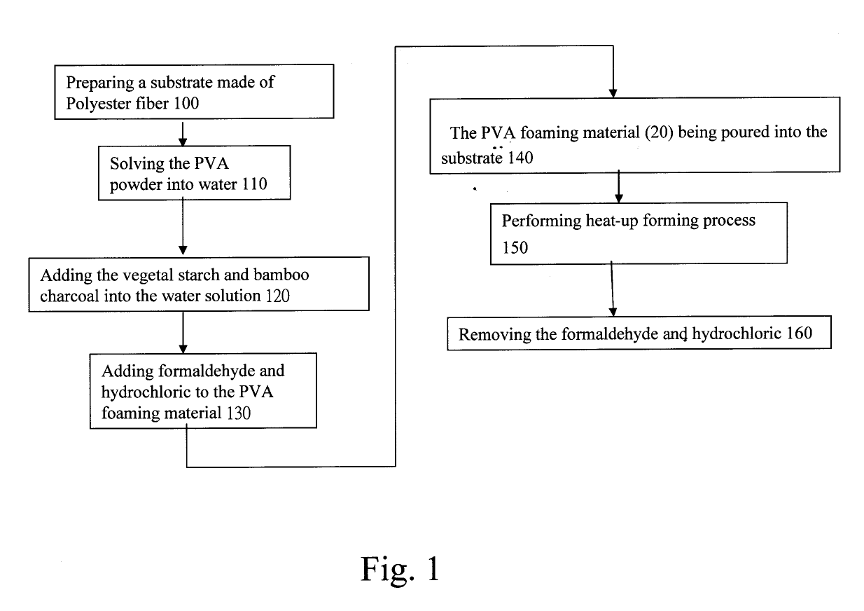

First, the forming steps of the present invention are illustrated in FIG. 1. A substrate 10 is made of Polyester fiber which contains many pores inside thereof. The pores are foaming pores or distributed like the beehive or net with a preferable density about 10 ppi to 45 ppi (pores per linear inch) so that a PVA foaming material 20 can be adequately soaked in the substrate 10 (step 140). The PVA foaming material 20 is formed by dissolving the PVA powder into water and then well agitating the solution at temperature between 75° C. to 95° C. (preferable at 90° C.) for one hour (step 110). Vegetal starch (such as potatoes powder) and bamboo charcoal are added to the solution between 55° C. to 75° C. (preferable under 65° C.). Above solution is well agitated between 25° C. to 40° C. (preferable at 35° C.) so that the foaming material 20 is formed. In the step 130, formaldehyde and hydrochloric acid are added to the foaming material 20.

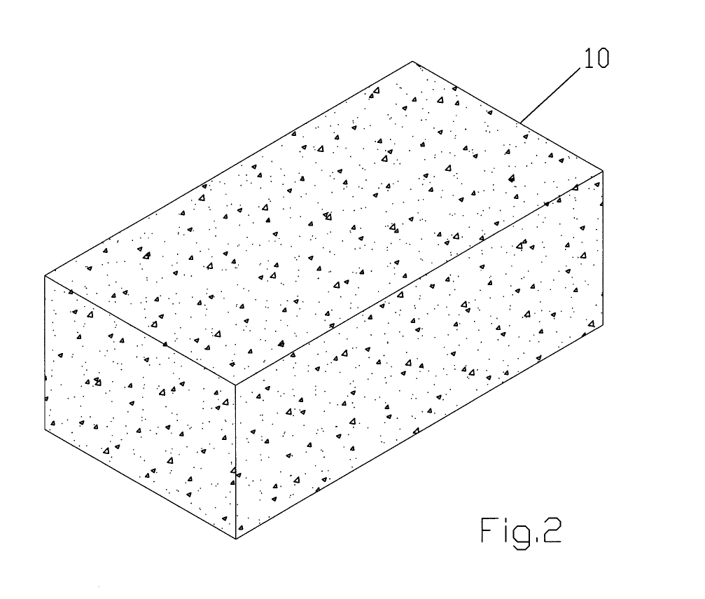

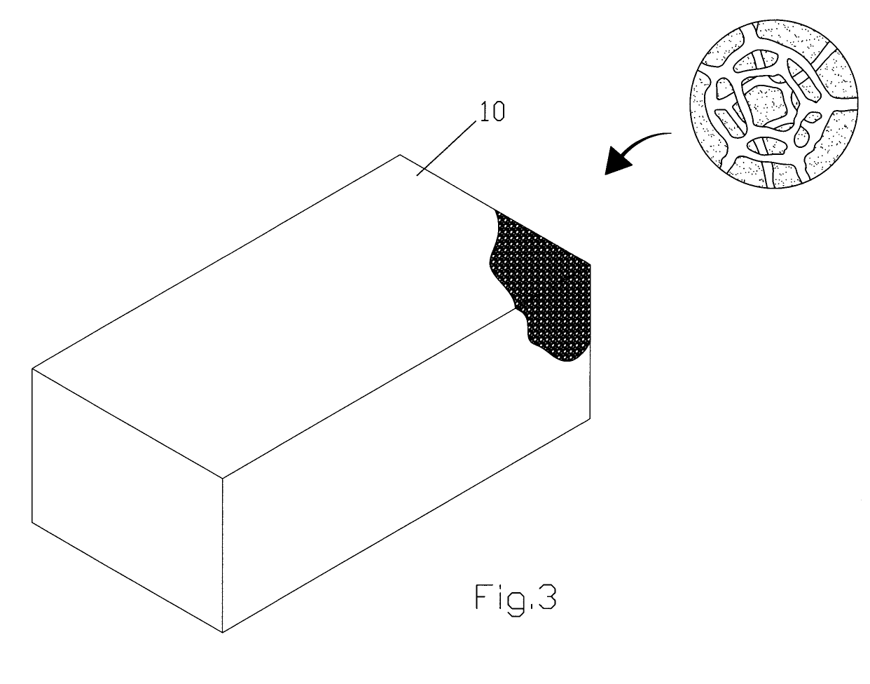

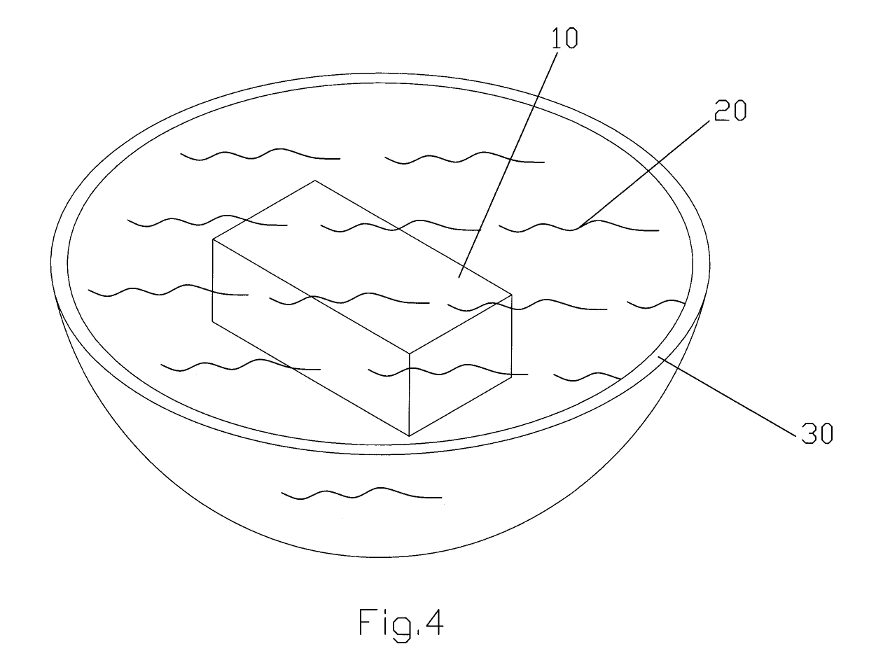

Further referring to FIGS. 2 and 3, schematic views of the structure are illustrated. The substrate 10 is placed into a container 30 with a predetermined shape as shown in FIG. 4. The PVA foaming material 20 is then poured into the container 30. The colloid PVA and formaldehyde will have acetalization so as to form pores (step 140).

The PVA foaming material 20 will be soaked into the pores of the substrate 10 and also will cover among the substrate 10 when the PVA foaming material 20 is poured into the container 30. A forming process at temperature between 30° C. to 70° C. (depend on how sticky it was) is carried on for 3 to 5 hours so that the material 20 is firmly combined with the substrate 10 as a sponge (step 150). The formaldehyde and hydrochloric will be removed while the above process is completed (step 160). The hydrochloric is an accelerator to accelerate the reaction. The vegetal starch will become paste at certain temperatures (such as 65° C.) and even become tighter with the raising temperature so as to make the structure stronger.

With the good tractility of the substrate 10, the sponge of the present invention will have a tenacious structure. Also, the PVA foaming material 20 will cover the fiber structure of the substrate 10 but the surface thereof will remain rough. Thus, the sponge of the present invention is formed.

The sponge structure made of the substrate 10 covered by the PVA foaming material 20 is capable of absorbing water fast. By the rough surface of the substrate 10 revealed from the sponge, the cleaning ability of the sponge will be extremely raised. The substrate 10 provides better tenacity and cleaning function to the sponge, and the life time is also lengthened because the substantial structure of the sponge. Therefore, the sponge can be applied to the mops and cleaning sponge for dinning dishes or bowls.

Therefore, the improved structure of the PVA foaming sponge according to the present invention still has the outstanding performance of absorbing water, and also has advanced cleaning effect. When the sponge is applied to mobs, the dirt and water will be adsorbed to it, and the dirt stuck on the floor will also be removed by the rough surface of the sponge. The sponge is also applied to dinning cleaning without extra process so that the cost is saving. The life time is lengthened by the tenacity and the comprehensive cleaning effect of the sponge so that it is economic and practical against the disadvantages of prior art.

The PVA foaming sponge of the present invention is more tight and resilient than the conventional PVA sponge. With the high ventilation thereof, water is also easier squeezed out. The bamboo charcoal is capable of purifying water and air, releasing mineral and ion, antiseptic, radiating far infrared, helping blood circulation, blocking electromagnetic wave, modulating temperature and humidity, and driving out the white ants. The bamboo charcoal also has outstanding ability of adsorption, deodorization, removing moisture and decomposing pernicious gases such as the solvent remained of house decoration. Therefore, the bamboo charcoal is added to the present invention so as to do good to human health. Moreover, The sponge of the present invention is capable of eliminating germs in the water while it is placed in the water.

The present invention is thus described, it will be obvious that the same may be varied in many ways. For example, a curved plate or a non-plane plate as shown in FIG. 12 instead of a plane substrate 10 is applied to the touch panel for special operation conditions. Such variations are not to be regarded as a departure from the spirit and scope of the present invention, and all such modifications as would be obvious to one skilled in the art are intended to be included within the scope of the following claims.

What is claimed is:

1. A PVA (polyvinyl acetal) foaming sponge having vegetal starch and bamboo charcoal comprising:
at least one Polyester fiber substrate (10) having through pores inside thereof;
a PVA foaming material (20) having vegetal starch and bamboo charcoal therein; the substrate (10) being covered by the PVA foaming material (20) and having acetalization by formaldehyde;
wherein the substrate (10) is placed into a container (30) with a predetermined shape; the PVA foaming material (20) mixed with formaldehyde and hydrochloric is poured into the container (30); the colloid PVA and formaldehyde will have acetalization so that the PVA foaming material (20) will cover among the structure of the substrate (10); a heating-up forming process is carried out when the formaldehyde is full of the container (30); the hydrochloric is an accelerator to accelerate the reaction.

2. The PVA foaming sponge having vegetal starch and bamboo charcoal as claimed in claim 1, the vegetal starch is potatoes powder.

3. The PVA foaming sponge having vegetal starch and bamboo charcoal as claimed in claim 1, the pores of the Polyester fiber substrate are one of foaming pores or pores distributed like the beehive or net.

4. A method for forming a PVA foaming sponge having vegetal starch and bamboo charcoal comprising the steps of:
preparing a substrate (10) made of Polyester fiber with many through pores inside thereof;
solving the PVA powder into water, and agitating the powder in water about 1 hour at temperatures between 75° C. [symbol] 95° C. for forming PVA water solution;
adding the vegetal starch and bamboo charcoal into the water solution and agitating above materials;
lowering the temperature of the water solution to 25 to 40° C. as a PVA foaming material (20), and adding formaldehyde and hydrochloric to the PVA foaming material (20);
placing the substrate (10) into a container (30) with a predetermined shape, and adding the PVA foaming material (20) into the container (30); the PVA foaming material (20) and formaldehyde having acetalization; the PVA foaming material (20) being soaked into the pores of the substrate (10) and also covering among the substrate (10) when the PVA foaming material (20) being poured into the container (30); the hydrochloric being an accelerator to accelerate the reaction;
performing heat-up forming process while the PVA foaming material (20) being full of the substrate (10); the process temperature being between 3070° C. depending on the adhesion thereof; the process time being 3 to 5 hours so as to combine the PVA foaming material (20) and the substrate (10) as the sponge; and
removing the formaldehyde and hydrochloric.

5. The method as claimed in claim 4, wherein the vegetal starch is potatoes powder.

6. The method as claimed in claim 4, wherein the pores of the Polyester fiber substrate are one of foaming pores or pores distributed like the beehive or net.

7. The method as claimed in claim 4, wherein the PVA powder is agitated in water about 1 hour at temperature of 90° C. for forming PVA water solution;

8. The method as claimed in claim 4, wherein the vegetal starch is added under temperature of 65° C.

9. The method as claimed in claim 4, wherein the temperature of the water solution is lowering to 30° C. as the PVA foaming material (20).
